(19) United States
(12) Patent Application Publication
(10) Pub. No.: US 2014/0345900 A1
(43) Pub. Date: Nov. 27, 2014

(54) ELECTRIC WIRE HOLDING STRUCTURE

(71) Applicant: Yazaki Corporation, Tokyo (JP)

(72) Inventors: Kazuaki SAITO, Kakegawa-shi (JP); Kotei O, Kakegawa-shi (JP)

(73) Assignee: YAZAKI CORPORATION, Tokyo (JP)

(21) Appl. No.: 14/284,717

(22) Filed: May 22, 2014

(30) Foreign Application Priority Data
May 27, 2013 (JP) 2013-111216

(51) Int. Cl. H01B 17/16; H01B 17/58

(52) U.S. Cl. CPC H01B 17/16; H01B 17/58
USPC 174/68.3

(57) ABSTRACT

An electric wire holding structure includes a wiring passage in a shape of a groove in which an electric wire is arranged, and a lock part which is formed at a midstream of the wiring passage and which holds the electric wire in the wiring passage. The lock part has a protruding part which protrudes from a first groove wall of the wiring passage into inside of the wiring passage. At least one of the first groove wall provided with the protruding part and a second groove wall opposed to the first groove wall is displaced in position in a groove width direction with respect to a corresponding groove wall of the wiring passage at an upstream side or a down stream side which is continued from the wiring passage provided with the lock part.

### BACKGROUND

The present invention relates to an electric wire holding structure, and more particularly, to the electric wire holding structure for preventing disengagement of an electric wire by floating up or jumping out from a wiring passage having a groove-like shape in which the electric wire is arranged.

Generally, in an electric apparatus such as an electric junction box or a bus bar module, or in an electric component, an electric wire connected to the apparatus or the component is arranged along a wiring passage in a groove-like shape which is formed in a containing casing or housing. In this case, for the purpose of preventing the electric wire from jumping out from the wiring passage, various electric wire holding structures have been proposed (JP-A-2005-51877 and JP-A-2013-20815, for example).

According to JP-A-2005-51877, there is proposed such a structure that a pair of clamping projections are provided on a wiring face in a shape of a plate formed of resin, and an electric wire is held by being press-fitted between the clamping projections. Moreover, according to JP-A-2013-20815, it is proposed that a pair of restricting pieces are provided so as to be opposed to each other at upper ends of groove walls of a wiring passage in a groove-like shape, and that tip end faces of the restricting pieces which are opposed to each other are made inclined, having a distance between them matched with a size of an electric wire, thereby to prevent disengagement of the electric wire by floating up or jumping out from the wiring passage.

However, according to the electric wire holding structure disclosed in JP-A-2005-51877, it is necessary to form each one wire holding part for each of the electric wires. Moreover, in this structure, the electric wire is held by press-fitting it between a pair of the clamping projections, there is such anxiety that the electric wire may be damaged, when it is press-fitted. Further, in case where the electric wire has a large diameter, it is difficult to press-fit the electric wire, and in case where the electric wire has a small diameter, it is concerned that the electric wire slips out. On the other hand, according to JP-A-2013-20815, it is possible to contain a plurality of electric wires, because a pair of the restricting pieces are provided on an opening of the wiring passage. However, it is difficult to deal with a plurality of the electric wires having respectively different diameters, because the diameters of the electric wires are restricted by the distance between a pair of the regulating pieces.

### SUMMARY

An object of the invention is to provide an electric wire holding structure which can hold an electric wire without press-fitting it, and can deal with a plurality of electric wires having different diameters.

In order to solve the above described problem, there is provided, according to the invention, an electric wire holding structure including a wiring passage in a shape of a groove in which an electric wire is arranged; and a lock part which is formed at a midstream of the wiring passage and which holds the electric wire in the wiring passage, wherein the lock part has a protruding part which protrudes from a first groove wall of the wiring passage into inside of the wiring passage, and wherein at least one of the first groove wall provided with the protruding part and a second groove wall opposed to the first groove wall is displaced in position in a groove width direction with respect to a corresponding groove wall of the wiring passage at an upstream side or a down stream side which is continued from the wiring passage provided with the lock part.

For example, a part of the first groove wall provided with the protruding part is displaced in position in the groove width direction with respect to other part of the first groove wall being continuous to the part of the first groove wall provided with the protruding part.

Also, for example, a part of the second groove wall opposed to a part of the first groove wall provided with the protruding part is displaced in position in the groove width direction with respect to other part of the second groove wall being continuous to the part of the second groove wall.

Specifically, the lock part is formed only by protruding the protruding part into the wiring passage of the electric wire. Therefore, it is possible to hold the electric wire by inserting it through a gap formed between a tip end of the protruding part and the second groove wall into a lower side of the protruding part (a space between the protruding part and a bottom face of the wiring passage). In short, it is possible to prevent disengagement of the electric wire by floating up or jumping out from the wiring passage. As the results, the electric wire can be held by the lock part without being press-fitted, and damage of the electric wire can be prevented. Moreover, even though a diameter of the electric wire is somewhat different, it is possible to insert the electric wire into the space between the protruding part and the bottom face of the wiring passage to be held therein. Further, in case where the protruding part is formed of elastically deformable resin, it is possible to easily insert the electric wire into the space below the protruding part, even though the electric wire has a rather larger diameter.

Herein, a specific feature in which at least one of the first groove wall provided with the protruding part and the second groove wall opposed thereto is displaced (shifted) in position in the groove width direction with respect to the groove wall of the wiring passage at the upstream side or the downstream side which is continued from the wiring passage having the lock part can be realized by displacing (shifting) in position the first groove wall while keeping at least a groove width of the lock part. Alternatively, this can be realized by displacing (shifting) in position the second grove wall which is opposed to the first groove wall provided with the protruding part in a direction of spreading the groove width. Further, this can be also realized by displacing (shifting) a wiring axis (an extending direction of the wiring passage) of at least one of the wiring passage at the upstream side and the downstream side continued from the wiring passage having the lock part, with respect to the other.

Moreover, in the electric wire holding structure, it is possible to form a suspended part which is suspended from a tip end of the protruding part toward a bottom face of the wiring passage. This is preferably applied to a case where bottom faces of the wiring passage at the upstream side and the downstream side which are continued from the wiring passage having the lock part are provided with step differences from each other. Specifically, in case of the wiring passage which has a three-dimensional bottom face having the step differences, the electric wire is subjected to an upwardly directed force (a jumping force) due to rigidity of the electric wire or so. In view of the above, the lock part according to the invention is provided on the bottom face or the groove wall of the wiring passage in a lower part of the step difference. As the results, the electric wire is pushed into a U-shaped space which is formed by the groove wall, the protruding part and the suspended part, and can be reliably prevented from being disengaged from the lock part.

Moreover, a protruding length of the protruding part is set so that a distance D1 from the first groove wall to a tip end of the protruding part is larger than the largest diameter of the electric wire, and a distance D2 from the tip end of the protruding part to the second groove wall, and a distance D3 from a lower end of the protruding part to the nearest bottom face of the wiring passage are respectively set so that at least the electric wire having the largest diameter can pass the distance D2 and the distance D3 through.

Also, for example, the protruding length of the protruding part is set so that the distance D1 from the first groove wall to a tip end of the protruding part is larger than the largest diameter of the electric wire, and a distance D2 from the suspended part to the second groove wall, and a distance D4 from a lower end of the suspended part to the nearest bottom face of the wiring passage are respectively set so that at least the electric wire having the largest diameter can pass the distance D2 and the distance D4 through.

Further, at least one side of the suspended part may be formed longer than a width of the tip end of the protruding part along a wiring direction of the electric wire. Particularly, in case of the wiring passage which has the three-dimensional bottom face having the step differences, the electric wire which is positioned between the lower step and the upper step has a smaller engaging length with the suspended part. However, according to this feature, it is possible to sufficiently secure the engaging length, by making at least one side of the suspended part longer than the width of the tip end of the protruding part.

In case where the electric wire is bended due to a shape of the wiring passage, it would be preferable that the protruding part is provided on the groove wall at the side where the electric wire is displaced. Then, the electric wire is pressed against the groove wall of the U-shaped space in the lock part due to rigidity of the electric wire or so. As the results, it is possible to reliably prevent the electric wire from being disengaged from the lock part. This is preferably applied to a case where the wiring passage has a lot of curves although on a flat face, or to a case where the wiring axis of the wiring passage in a straight shape is shifted in position.

According to this invention, it is possible to provide an electric wire holding structure which can hold an electric wire without press-fitting it, and can deal with a plurality of electric wires having different diameters.

### BRIEF DESCRIPTION OF THE DRAWINGS

FIG. 1A is a plan view of an essential part of Embodiment 1 of an electric wire holding structure according to the invention.

FIG. 1B is a sectional view of the essential part of Embodiment 1 of the electric wire holding structure according to the invention.

FIG. 2 is a plan view of an essential part of Embodiment 2 of the electric wire holding structure according to the invention.

FIG. 3 is a plan view of an essential part of Embodiment 3 of the electric wire holding structure according to the invention.

FIG. 4A is an elevation view of an essential part of Embodiment 4 of the electric wire holding structure according to the invention.

FIG. 4B is a sectional view of the essential part of Embodiment 4 of the electric wire holding structure according to the invention.

FIG. 5 is an elevation view of an essential part of Embodiment 5 of the electric wire holding structure according to the invention.

### DETAILED DESCRIPTION OF THE EXEMPLARY EMBODIMENTS

Now, an electric wire holding structure according to the invention will be described referring to embodiments.

### Embodiment 1

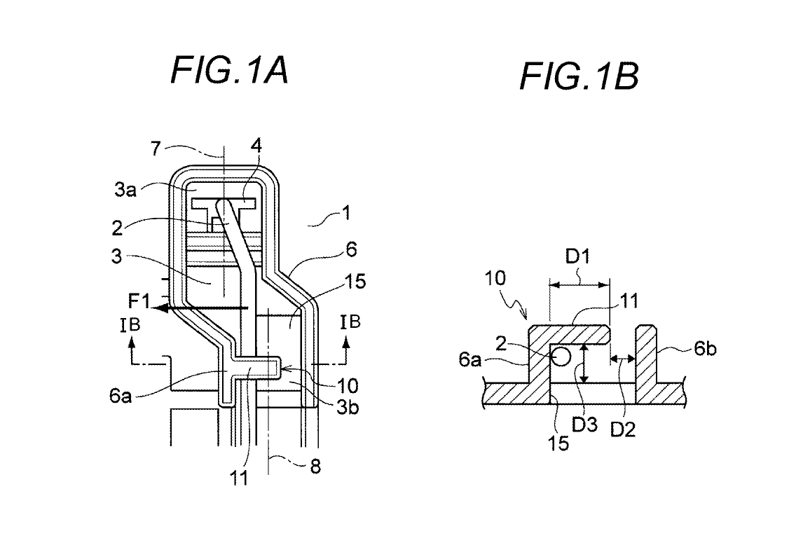

FIG. 1A is a plan view showing an essential part of Embodiment 1 in which the electric wire holding structure according to the invention is applied to a wiring passage of an electric wire to be connected to a device or a component in an electric apparatus such as an electric junction box. FIG. 1B is a sectional view as seen from arrow marks IB-IB in FIG. 1A. As shown in FIG. 1A, a wiring passage 3 where an electric wire 2 is arranged is integrally formed on a surface of a wiring board 1 which is formed of resin and provided inside a casing of the electric apparatus. The wiring passage 3 in this embodiment is formed in a groove-like shape between groove walls 6 which are formed near a through hole 4 for wiring the electric wire 2 from one face (surface) to the other face (back face) of the board 1. Moreover, an extending direction of the wiring passage 3 in this embodiment is curved within a plane of the board 1, ahead of the through hole 4. Specifically, a wiring axis 7 of a wiring passage 3a passing a center of the through hole 4 and a wiring axis 8 of a wiring passage 3b which is apart from the through hole 4 are displaced in position (displaced or shifted) within the board 1. In other words, in this embodiment, a protruding part 11 is formed so as to protrude from one groove wall 6a (first groove wall) of the groove walls 6 in the wiring passage 3b into the wiring passage 3b. Then, the one groove wall 6a provided with the protruding part 11 and the other groove wall 6b (second groove wall) which is opposed thereto are displaced in position (shifted) in a groove width direction, with respect to groove walls of the wiring passage 3a which is continued from the wiring passage 3b having a lock part 10.

There is formed the lock part 10 having the protruding part 11 which is protruded into the wiring passage 3b from an upper end of the groove wall 6a of the wiring passage 3b at the shifted position. Specifically, the lock part 10 is composed of the protruding part 11, and a pair of the groove walls 6a, 6b of the wiring passage 3b at the position where the protruding part 11 is formed. As shown in FIG. 1B, a protruding length D1 of the protruding part 11 from the groove wall 6a is determined to be larger than the largest diameter of the electric wire 2. Moreover, a distance D2 between a tip end of the protruding part 11 and the other groove wall 6b, and a distance D3 between a lower face of the protruding part 11 and the nearest bottom face of the wiring passage 3a, which is a surface of the board 1, in a depicted embodiment, are set so that at least the electric wire 2 having the largest diameter can pass them through. In this embodiment, the board 1 is provided with a through hole 15 at the position where the lock part 10 is provided. However, the through hole 15 must not be necessarily formed, and the wiring passage 3a may be extended in a straight shape.

According to the electric wire holding structure which is formed in this manner, the groove wall 6a and the protruding part 11 are formed in a hook-like shape, when the lock part 10 is seen from a wiring direction of the electric wire 2. Therefore, by inserting the electric wire 2 to a lower face side of the protruding part 11 through a gap between the tip end of the protruding part 11 and the groove wall 6b, it is possible to hold the electric wire in a U-shaped space of the lock part 10 which is formed between the groove wall 6a, the protruding part 11, and the bottom face of the wiring passage 3b. As the results, it is possible to allow the lock part 10 to hold the electric wire 2 without press-fitting, and hence, the electric wire 2 can be prevented from being damaged. Moreover, even though the diameter of the electric wire is somewhat different, it is possible to insert the electric wire 2 into the space having the distance D3 between the lower face of the protruding part 11 and the bottom face of the wiring passage 3b (the surface of the board 1). Particularly, because the lock part 10 is formed of elastically deformable resin, it is possible to insert the electric wire into the space in the lock part 10, even though the electric wire has a rather larger diameter. As described above, according to this embodiment, by providing the lock part 10, it is possible to prevent the electric wire 2 from floating up. Moreover, in this embodiment, because the wiring axes of the wiring passage 3a and the wiring passage 3b are shifted from each other, the electric wire 2 is crooked, as shown in the drawings. However, according to this embodiment, the protruding part 11 is provided on the groove wall 6a at a side where the electric wire 2 is displaced, and the electric wire 2 is pressed against the groove wall 6a of the U-shaped space in the lock part 10 with a force F1 which is generated by rigidity of the electric wire 2. As the results, it is possible to reliably prevent the electric wire 2 from being disengaged from the lock part 10.

### Embodiment 2

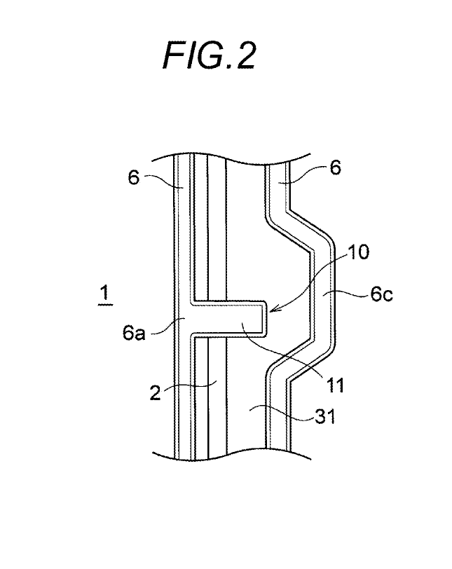

FIG. 2 shows an example of a wiring passage 31 in Embodiment 2, in which the electric wire 2 is two-dimensionally wired, in the same manner as in Embodiment 1. The wiring passage 31 in this embodiment is a preferable example in case where the protruding length of the protruding part 11 of the lock part 10 is larger than a groove width of the wiring passage 31. Specifically, the wiring passage 31 cannot have a sufficiently large groove width, in some cases, due to restrictions such as arrangements of associated components. In such cases, it would be preferable to spread the groove wall 6c outward at the position where the lock part 10 is provided, as shown in FIG. 2, thereby to make the distance between the tip end of the protruding part 11 and the groove wall 6c larger than the diameter of the electric wire 2. In this case, the groove width of only a part of the wiring passage 31 has to be enlarged, and therefore, it is possible to easily apply the lock part according to the invention. The other technical advantages are substantially the same as those in Embodiment 1.

### Embodiment 3

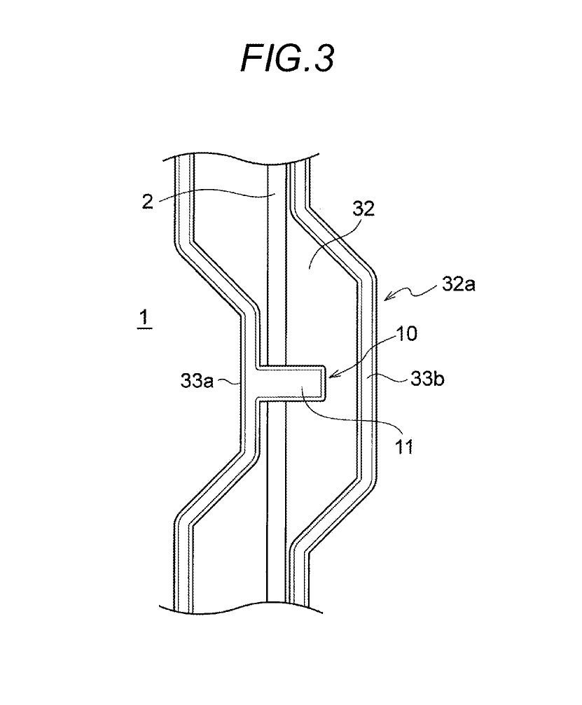

FIG. 3 is a plan view of Embodiment 3 of the electric wire holding structure according to the invention. This embodiment is an example in which on occasion of forming a wiring passage 32 in a groove-like shape on the board 1 having a two-dimensional shape, a crooked part 32a is formed in a part of the wiring passage 32, for the purpose of avoiding other components to be mounted on the board 1, or for the purpose of enhancing wire holding performance of the lock part 10 according to the invention. By forming the crooked part 32a in the wiring passage 32 as in this embodiment, it is possible to easily apply the lock part 10 according to the invention thereby to realize the rigid electric wire holding structure. Specifically, by crooking the wiring passage 32 in this manner, the protruding part 11 of the lock part 10 is formed on a groove wall 33a at the side where the electric wire 2 is displaced. As the results, the electric wire 2 is pushed leftward in the drawing, by front and back parts of the wiring passage 32 continued from a part of the wiring passage 32 where the lock part 10 is provided. Accordingly, a force for pushing the electric wire 2 to a lower side of the protruding part 11 of the lock part 10 is exerted on the electric wire 2 than a force for disengaging the electric wire 2 from the lock part 10, and hence, the electric wire 2 is rigidly held. Naturally, it is possible to more reliably hold the electric wire 2, as compared with a case where the protruding part is provided on a groove wall 33b at the opposite side.

In this Embodiment 3, the part of the wiring passage 32 having the lock part 10 is displaced with respect to wiring axes (extending directions of the wiring passages) of the front and back parts of the wiring passage 32 continued from the part of the wiring passage 32 having the lock part 10. However, it is possible to displace the wiring axis of either one of the front and back parts of the wiring passage 32 continued from the part of the wiring passage 32 having the lock part 10, with respect to the wiring passage 32 having the lock part 10. In this case too, substantially the same effects can be obtained.

### Embodiment 4

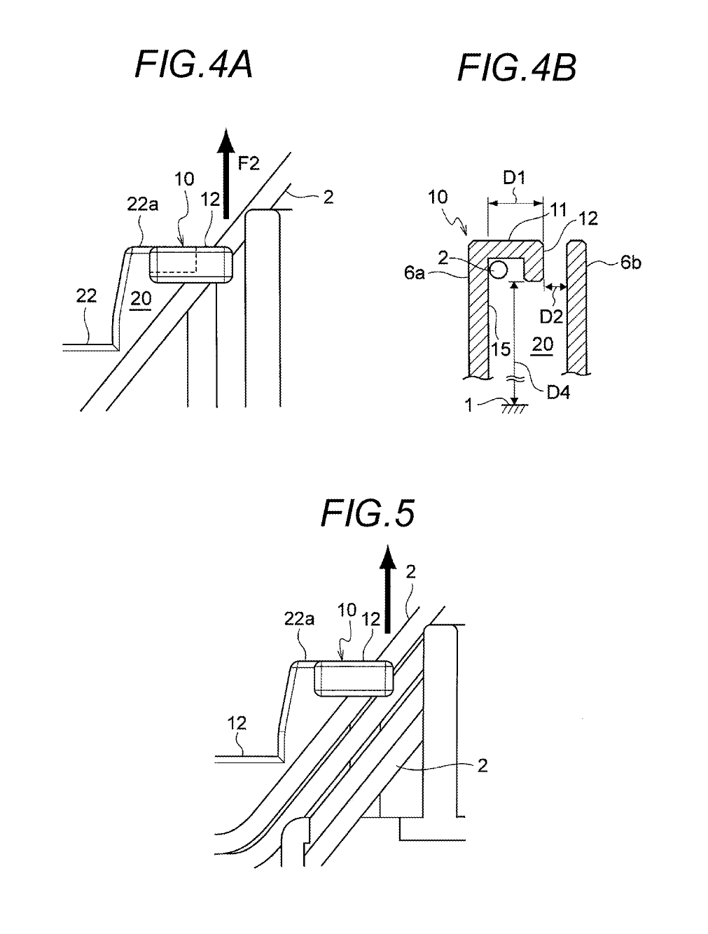

FIG. 4A is an elevation view showing an essential part of Embodiment 4 in which the electric wire holding structure according to the invention is applied to a wiring passage of an electric wire to be connected to a device or a component in an electric apparatus such as an electric junction box. FIG. 4B is a sectional view of the lock part 10. In this embodiment, the lock part 10 according to the invention is applied to the electric wire holding structure of the wiring passage which has a three-dimensional bottom face having step differences. A wiring passage 20 in FIG. 4A is an example in which the electric wire 2 is arranged between a lower step at the left side and a higher step at the right side in the drawing. In such a case, it is difficult to form the wiring passage which is provided with such ideal groove walls as in Embodiment 1. Groove walls 22 in this embodiment are formed in a step-like shape, and the lock part 10 is provided, by protruding a protruding part from an upper end of a groove wall 22a, in a midstream of the wiring passage 20.

As shown in FIG. 4B, the lock part 10 is formed by including a protruding part 11, and a suspended part 12 which is suspended from a tip end of the protruding part 11 toward a bottom face of the wiring passage 20 along the groove wall 22a. The suspended part 12 is formed in such a manner that a distance D2 between the suspended part 12 and the other groove wall 22b opposed to the groove wall 22a is set so that at least the electric wire 2 having the largest diameter can pass it through. Moreover, in this embodiment, a distance D4 between a lower end of the suspended part 12 and the nearest bottom face of the wiring passage is so set that the electric wire 2 having the largest diameter can sufficiently pass it through. However, it is necessary to determine the distance D4 so that at least the electric wire 2 having the largest diameter can pass it through in any case.

According to Embodiment 4, it is possible to easily insert the electric wire 2 from the lower end of the suspended part 12 to a lower side of the protruding part 11. Then, the electric wire 2 can be held in a U-shaped space of the lock part 10 which is formed by the groove wall 22a, the protruding part 11, and the suspended part 12. As the results, the electric wire 2 can be held by the lock part 10 without being press-fitted, and therefore, it is possible to prevent the electric wire 2 from being damaged. Moreover, even though the electric wire has a somewhat different diameter, it is possible to insert the electric wire 2 below the protruding part 11, since there is a sufficiently large distance between the lower end of the suspended part 12 and the bottom of the wiring passage 20.

Particularly, in this embodiment, because the bottom face of the wiring passage 20 has the step differences, the electric wire 2 is three-dimensionally crooked, and subjected to a force in a direction of F2 in the drawing, due to rigidity of the electric wire 2 or so. Accordingly, the electric wire 2 is pressed against the protruding part 11 of the lock part 10. Moreover, the suspended part 12 is formed so as to extend longer than a width of the tip end of the protruding part 11 toward the upper step of the wiring passage 20, along the wiring direction of the electric wire 2. Therefore, it is possible to secure a sufficient engaging length of the electric wire 2 which is positioned between the lower step and the upper step, with respect to the suspended part 12, and it is possible to stably hold the electric wire 2.

### Embodiment 5

FIG. 5 shows Embodiment 5 which is a modification of Embodiment 4. This embodiment is different from Embodiment 4 in that a plurality of the electric wires 2 are held by the same lock part 10. Because other members in Embodiment 5 are the same as those in Embodiment 4, the other members are denoted with the same reference numerals, and their description will be omitted. In this embodiment, the suspended part 12 is formed longer than the width of the tip end of the protruding part 11. Therefore, in case of the wiring passage 20 having such a structure that the electric wires 2 can be arranged in a superposed manner in a vertical direction, even though the electric wires 2 are not neatly positioned in the U-shaped space of the lock part 10, it is possible to hold a plurality of the electric wires 2, because a plurality of the electric wires are engaged with the suspended part 12.

Although the invention has been heretofore described referring to several embodiments, the invention is not limited to these embodiments. It would be apparent to those skilled in the art that the invention can be carried out in modified or amended modes within a scope not deviating from the gist of the invention. It is a matter of course that the modified or amended modes also belong to the scope of claims of this application.

For example, in Embodiments 1, 2 and 3, the examples in which the lock part 10 is not provided with the suspended part 12 have been described. However, it is needless to say that also in Embodiments 1 to 3, the lock part 10 which is provided with the suspended part 12, as shown in Embodiments 4 and 5, can be applied.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japanese Patent Application No. 2013-111216 filed on May 27, 2013, the contents of which are incorporated herein by reference.

What is claimed is:

1. An electric wire holding structure comprising:
a wiring passage in a shape of a groove in which an electric wire is arranged; and
a lock part which is formed at a midstream of the wiring passage and which holds the electric wire in the wiring passage,
wherein the lock part has a protruding part which protrudes from a first groove wall of the wiring passage into inside of the wiring passage; and
wherein at least one of the first groove wall provided with the protruding part and a second groove wall opposed to the first groove wall is displaced in position in a groove width direction with respect to a corresponding groove wall of the wiring passage at an upstream side or a down stream side which is continued from the wiring passage provided with the lock part.

2. The electric wire holding structure according to claim 1, wherein a part of the first groove wall provided with the protruding part is displaced in position in the groove width direction with respect to other part of the first groove wall being continuous to the part of the first groove wall provided with the protruding part.

3. The electric wire holding structure according to claim 1, wherein a part of the second groove wall opposed to a part of the first groove wall provided with the protruding part is displaced in position in the groove width direction with respect to other part of the second groove wall being continuous to the part of the second groove wall.

4. The electric wire holding structure according to claim 1, wherein the protruding part has a suspended part which is suspended from a tip end thereof toward a bottom face of the wiring passage; and
wherein a bottom face of the wiring passage at the upstream side or the downstream side which is continued from the wiring passage provided with the lock part and the bottom face of the wiring passage provided with the lock part form a step difference.

5. The electric wire holding structure according to claim 1, wherein a protruding length of the protruding part is set so that a distance D1 from the first groove wall to a tip end of the protruding part is larger than the largest diameter of the electric wire; and
wherein a distance D2 from the tip end of the protruding part to the second groove wall, and a distance D3 from a lower end of the protruding part to the nearest bottom face of the wiring passage are respectively set so that at least the electric wire having the largest diameter can pass the distance D2 and the distance D3 through.

6. The electric wire holding structure according to claim 4, wherein the protruding length of the protruding part is set so that the distance D1 from the first groove wall to a tip end of the protruding part is larger than the largest diameter of the electric wire; and
wherein a distance D2 from the suspended part to the second groove wall, and a distance D4 from a lower end of the suspended part to the nearest bottom face of the wiring passage are respectively set so that at least the electric wire having the largest diameter can pass the distance D2 and the distance D4 through.

7. The electric wire holding structure according to claim 4, wherein at least one side of the suspended part is formed longer than a width of the tip end of the protruding part along a wiring direction of the electric wire.
